(19) United States
(12) Patent Application Publication
(10) Pub. No.: US 2026/0129721 A1
(43) Pub. Date: May 7, 2026

(54) HEATING ASSEMBLY AND VEHICLE CAMERA SYSTEM

(71) Applicant: TPK Glass Solutions (Xiamen) Inc., Xiamen (CN)

(72) Inventors: Ting-Ying LIU, Xiamen city (CN); Tai-Shih CHENG, Taipei city (TW); Wei-Yi LIN, Taoyuan City (TW); An-Lun HAN, New Taipei City (TW); Feng-Cheng HSU, Taipei City (TW)

(21) Appl. No.: 19/370,589

(22) Filed: Oct. 27, 2025

(30) Foreign Application Priority Data
Nov. 6, 2024 (CN) 202411577704.5

(51) Int. Cl. H05B 3/84; C03C 17/34; G02B 27/00; H05B 1/02; H05B 3/18

(52) U.S. Cl. CPC H05B 3/84; C03C 17/3417; G02B 27/0006; H05B 1/0236; H05B 3/18; C03C 2217/213; C03C 2217/218; C03C 2217/734; H05B 2203/013

(57) ABSTRACT

A heating assembly includes an electric heating plate, a primary thermal conductive layer, a first insulating layer covering the primary thermal conductive layer, an auxiliary thermal conductive layer covering the first insulating layer, and a driving power supply. The electric heating plate comprises a glass layer, a transparent conductor layer disposed on the glass layer, and a decorative layer disposed between the glass layer and the transparent conductor layer. The decorative layer defines a light-transmitting window area and a light-impermeable area. The primary thermal conductive layer comprises two electrical connectors, respectively disposed on opposite sides of the transparent conductor layer. The transparent conductor layer has a first line impedance between the electrical connectors. The auxiliary thermal conductive layer has a second line impedance matching the first line impedance. The driving power supply applies a driving voltage to the primary thermal conductive layer and the auxiliary thermal conductive layer in parallel.

### CROSS-REFERENCE TO RELATED APPLICATION

This application claims priority to China Patent Application 202411577704.5, filed Nov. 6, 2024, which is incorporated herein by reference.

### FIELD OF DISCLOSURE

The present disclosure relates to a heating assembly and a vehicle camera system.

### DESCRIPTION OF RELATED ART

Light detection and ranging (LiDAR) systems are based on a remote sensing technology that uses light to measure distances or shapes of objects. LiDAR systems have been implemented in many areas, including autonomous vehicles, unmanned aerial drones, topographic surveys, and environmental monitoring.

However, LiDAR systems can be interfered with under various environmental factors in actual applications. Among all environmental factors, moisture and ice especially pose a significant impact on LiDAR systems. For example, small particles in moisture or ice will scatter the laser light and cause the light to lose partial energy, and, in some cases, the light cannot even return to the receiver, resulting in lesser accuracy in measurement. A water molecule can absorb laser light, especially light of specific wavelengths, which further weakens the returning laser signals. While transmitting through moisture or ice, a travel path of light may change due to reflection, causing measurement errors. Laser light may undergo multiple reflections within the moisture or ice and generate multiple return waves, leading to the LiDAR system failing to detect the distance of the target object accurately.

Therefore, the solution that can solve the aforementioned problems of heating assemblies and vehicle camera systems is where the industry focuses its research efforts and development resources, and intends to achieve.

### SUMMARY

In view of this, one objective of the present disclosure is to provide a heating assembly and vehicle camera system that can solve the aforementioned problems.

According to one embodiment of the present disclosure, to achieve the aforementioned objective, a heating assembly comprises an electric heating plate, a primary thermal conductive layer, a first insulating layer, an auxiliary thermal conductive layer, and a driving power supply. The electric heating plate comprises a glass layer, a transparent conductor layer, and a decorative layer. The transparent conductor layer is disposed on the glass layer. The decorative layer is disposed between the glass layer and the transparent conductor layer and defines a light-transmitting window area and a light-impermeable area. The primary thermal conductive layer comprises two electrical connectors, and the electrical connectors are respectively disposed on opposite sides of the transparent conductor layer. The transparent conductor layer has a first line impedance between the electrical connectors. The first insulating layer covers the primary thermal conductive layer. The auxiliary thermal conductive layer comprises an opaque metal or metal composition and covers the first insulating layer. The auxiliary thermal conductive layer forms a patterned continuous wiring corresponding to the decorative layer and at least partially overlaps the primary thermal conductive layer in a stacking direction of the primary thermal conductive layer. The auxiliary thermal conductive layer has a second line impedance matching the first line impedance. The driving power supply applies a driving voltage to the primary thermal conductive layer and the auxiliary thermal conductive layer in parallel.

In one or several embodiments of the present disclosure, the primary thermal conductive layer is configured with a first heating mode to start when power is on so that the light-transmitting window area is heated evenly. The auxiliary thermal conductive layer is configured with a second heating mode to start when power is on so that the light-impermeable area is heated, and the second heating mode and the first heating mode are operated simultaneously.

In one or several embodiments of the present disclosure, each of the two electrical connectors has a resistance value smaller than 1 Ohm.

In one or several embodiments of the present disclosure, the first line impedance is in a range of 25 Ohms to 35 Ohms.

In one or several embodiments of the present disclosure, a resistance difference between the second line impedance and the first line impedance is about 3% to 5%.

In one or several embodiments of the present disclosure, the light-transmitting window area has two edges opposite to each other. The two electrical connectors at least partially overlap the two edges in the stacking direction, respectively.

In one or several embodiments of the present disclosure, the heating assembly further comprises a first anti-reflection layer and a second anti-reflection layer. The first anti-reflection layer is disposed on one side of the glass layer away from the transparent conductor layer. The second anti-reflection layer is disposed on one side of the transparent conductor layer away from the glass layer.

In one or several embodiments of the present disclosure, the heating assembly further comprises a hydrophobic coating layer. The hydrophobic coating layer is disposed on one side of the first anti-reflection layer that is away from the glass layer.

In one or several embodiments of the present disclosure, the heating assembly further comprises a second insulating layer. The second insulating layer covers the auxiliary thermal conductive layer.

According to one embodiment of the present disclosure, in order to achieve the aforementioned objective, a vehicle camera system comprises the aforementioned heating assembly and a lens. The lens is located on one side of the electric heating plate where the primary thermal conductive layer is disposed on and aligned with the light-transmitting window area in the stacking direction.

In summary, through a double-layer design of a primary thermal conductive layer and an auxiliary thermal conductive layer, paired with a first line impedance of the transparent conductor layer between the electrical connectors and a second line impedance of the auxiliary thermal conductive layer that matches the first line impedance in design, not only can the heating coverage area of the heating assembly of the present disclosure increase, but the primary thermal conductive layer and the auxiliary thermal conductive layer can separately achieve two different heating modes simultaneously according to the needs of the environment. Furthermore, the two edges of the electric heating plate of the heating assembly, opposite to each other, are disposed with a first anti-reflection layer and a second anti-reflection layer, respectively, to increase the transmittance of the electric heating plate so that the vehicle camera system of the present disclosure can meet the dynamic specification of autopilot lenses.

The aforementioned statements are only used to explain problems that can be solved by the present disclosure, the technical means for solving the problems, and the effect thereof. The present disclosure will be fully understood from the following detailed descriptions of the embodiments with reference to the accompanying drawings that are for illustration only.

### BRIEF DESCRIPTION OF THE DRAWINGS

To enable better understanding of the aforementioned and other objectives, novel features, advantages, embodiments, and the effect of the present disclosure, diagrams are provided as follows:

FIG. 1 is a schematic diagram of the vehicle camera system of an embodiment of the present disclosure.

FIG. 2A is a schematic diagram of the front view of the heating assembly of an embodiment of the present disclosure.

FIG. 2B is a schematic diagram of the rear view of the heating assembly of FIG. 2A.

FIG. 3 is a schematic diagram of the auxiliary thermal conductive layer of an embodiment of the present disclosure.

FIG. 4 is a flow block diagram of the primary thermal conductive layer, the auxiliary thermal conductive layer, and the driving power supply.

FIG. 5 is a wavelength-reflectance curve of light having an angle of incidence of 0 degrees to the outer side of the heating assembly away from the lens in FIG. 1.

FIG. 6 is a wavelength-reflectance curve of light having an angle of incidence of 30 degrees to the outer side of the heating assembly in FIG. 1.

FIG. 7 is a wavelength-reflectance curve of light having an angle of incidence of 42 degrees to the outer side of the heating assembly in FIG. 1.

FIG. 8 is a wavelength-reflectance curve of light having an angle of incidence of 0 degrees to the inner side of the heating assembly close to the lens in FIG. 1.

FIG. 9 is a wavelength-reflectance curve of light having an angle of incidence of 30 degrees to the inner side of the heating assembly in FIG. 1.

FIG. 10 is a wavelength-reflectance curve of light having an angle of incidence of 42 degrees to the inner side of the heating assembly in FIG. 1.

### DETAILED DESCRIPTION

A plurality of embodiments of the present disclosure will be disclosed below with drawing references. For a clear illustration, many details in practice will be provided together with the following descriptions. However, these detailed descriptions in practice are for illustration only and shall not be interpreted to limit the scope, applicability, or configuration of the present disclosure in any way. That is, in some embodiments of the present disclosure, these details in practice are not required. Furthermore, to simplify the drawings, some structures and components of the prior art shown in the drawings will be illustrated schematically.

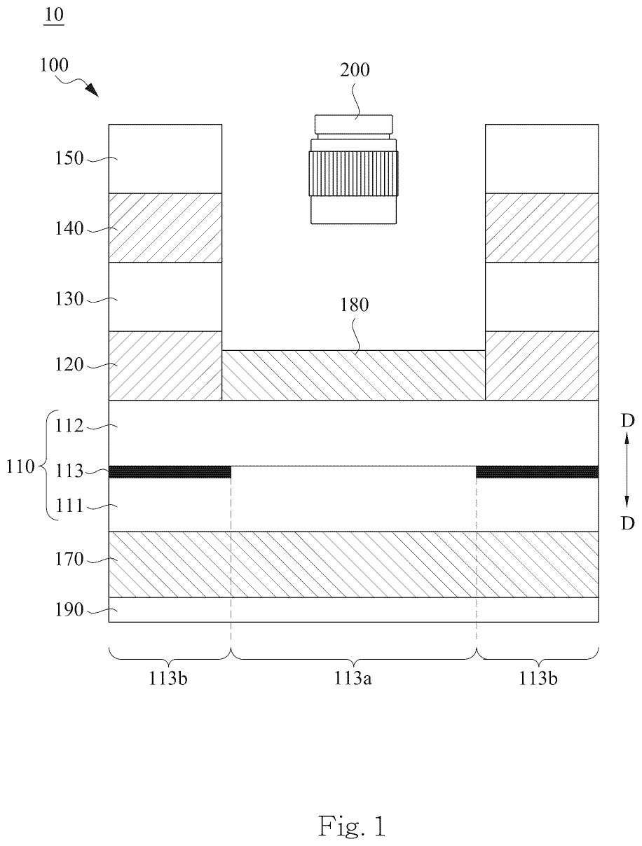

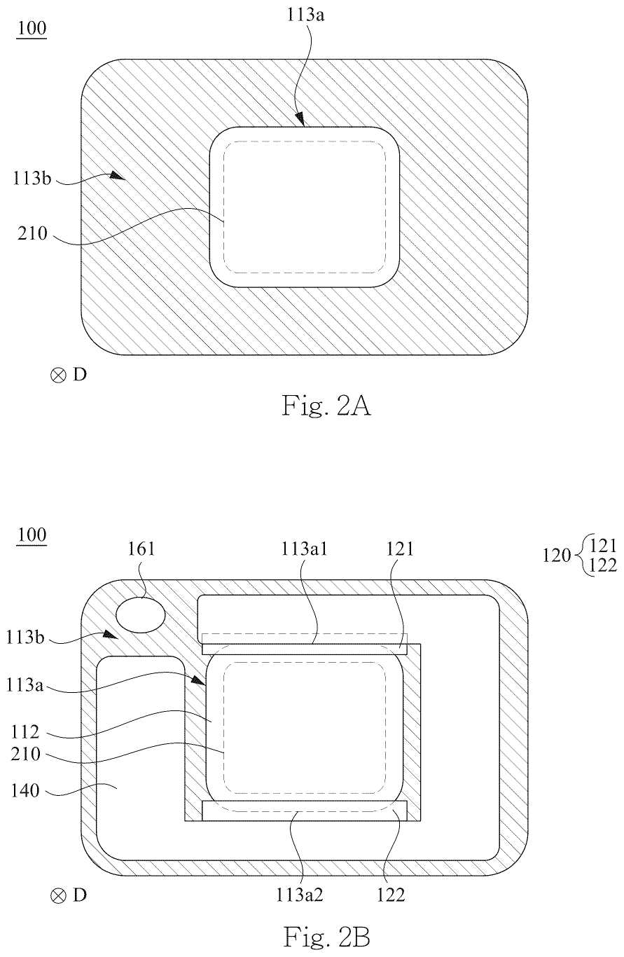

Please refer to FIG. 1, FIG. 2A, and FIG. 2B. FIG. 1 is a schematic diagram of the vehicle camera system 10 of an embodiment of the present disclosure. FIG. 2A is a schematic diagram of the front view of the heating assembly 100 of an embodiment of the present disclosure. FIG. 2B is a schematic diagram of the rear view of the heating assembly 100 of FIG. 2A. As shown in FIG. 1 to FIG. 2B, in the embodiment, the vehicle camera system 10 comprises a heating assembly 100 and a lens 200. The heating assembly 100 comprises an electric heating plate 110. The electric heating plate 110 comprises a glass layer 111, a transparent conductor layer 112, and a decorative layer 113. The transparent conductor layer 112 is disposed on the glass layer 111. The decorative layer 113 is disposed between the glass layer 111 and the transparent conductor layer 112 and defines a light-transmitting window area 113a and a light-impermeable area 113b. In other words, the light-impermeable area 113b defines the light-transmitting window area 113a by disposition therearound. The lens 200 is located on one side of the electric heating plate 110, where the primary thermal conductive layer 120 is disposed, and aligned with the light-transmitting window area 113a in the stacking direction D of the glass layer 111 and the transparent conductor layer 112. The aperture 210 of the lens 200 (shown in FIG. 2A and FIG. 2B by dashed lines) is located in the area within the outer edge of the light-transmitting window area 113a.

In several embodiments, materials of the transparent conductor layer 112 are composed of indium tin oxide (ITO) or other metal mesh conductive materials that do not affect visibility. However, the present disclosure is not limited thereto.

In several embodiments, the decorative layer 113 has a black mask coating that is formed on the transparent conductor layer 112 by applying black ink through, for example, a printing process. However, the present disclosure is not limited thereto.

In the embodiment, as shown in FIG. 1 to FIG. 2B, the heating assembly 100 further comprises a primary thermal conductive layer 120, a first insulating layer 130, an auxiliary thermal conductive layer 140, and a second insulating layer 150. The primary thermal conductive layer 120 comprises two electrical connectors 121, 122. The electrical connectors 121, 122 (also known as busbars) are respectively disposed on opposite sides of the transparent conductor layer 112. The first insulating layer 130 covers the primary thermal conductive layer 120; the auxiliary thermal conductive layer 140 covers the first insulating layer 130. The first insulating layer 130 is configured to electrically insulate the primary thermal conductive layer 120 from the auxiliary thermal conductive layer 140. The second insulating layer 150 covers the auxiliary thermal conductive layer 140. The second insulating layer 150 is configured to electrically insulate the auxiliary thermal conductive layer 140 from other electronic components within the vehicle camera system 10.

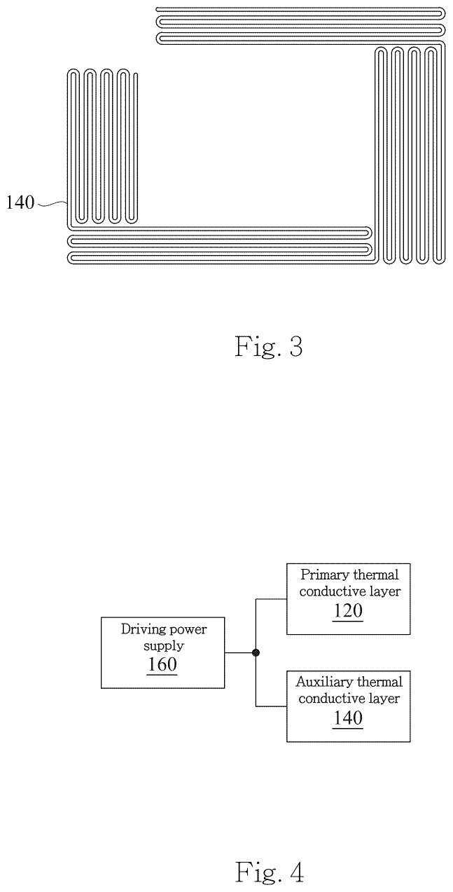

Please refer to FIG. 3, which is a schematic diagram of the auxiliary thermal conductive layer 140 of an embodiment of the present disclosure. In the embodiment, as shown in FIG. 2B and FIG. 3, the auxiliary thermal conductive layer 140 forms a patterned continuous wiring corresponding to the decorative layer 113, and at least partially overlaps the primary thermal conductive layer 120 in the stacking direction D of the primary thermal conductive layer 120. More specifically, the auxiliary thermal conductive layer 140 partially overlaps the electrical connectors 121, 122 in the stacking direction D. As shown in FIG. 3, the patterned continuous wiring of the auxiliary thermal conductive layer 140 is arranged in a multiple racetrack-type coil winding manner beginning from the upper edge of the light-transmitting window area 113a, to the right edge then the lower edge of the light-transmitting window area 113a, and finally to the left edge of the light-transmitting window area 113a in the specific given sequence. Therefore, the auxiliary thermal conductive layer 140 that is arranged around the outer edges of the two electrical connectors 121 and 122 of the primary thermal conductive layer 120 can increase the heating coverage area of the heating assembly 100.

Please refer to FIG. 4, which is a flow block diagram of the primary thermal conductive layer 120, the auxiliary thermal conductive layer 140, and the driving power supply 160. In the embodiment, as shown in FIG. 4, the heating assembly 100 further comprises a driving power supply 160. The driving power supply 160 applies a driving voltage to the primary thermal conductive layer 120 and the auxiliary thermal conductive layer 140 in parallel. More specifically, the driving power supply 160 feeds the electricity in the electrical connector 121 of the primary thermal conductive layer 120 and one end of the auxiliary thermal conductive layer 140 through the lap joint area 161 (for example, one end of the upper edge of the light-transmitting window area 113a in FIG. 2B), as shown in FIG. 2B. The electric current flowing into the electrical connector 121 will flow to the electrical connector 122 in the form of a current waterfall (that is, multiple electric currents flow from the entire electrical connector 121 as the starting point like a waterfall having multiple substantially parallel electric currents that flow separately straight to multiple locations on the electrical connector 122; the average resistance of each electric current path can be used to calculate the equivalent line resistance) through the transparent conductor layer 112 at the locations between the two electrical connectors 121, 122. The electric current flowing into one end of the aforementioned auxiliary thermal conductive layer 140 will flow along the patterned continuous wiring into the other end of the auxiliary thermal conductive layer 140 (for example, one end on the left edge of the light-transmitting window area 113a in FIG. 2B). Specifically, the transparent conductor layer 112 has a first line impedance between the electrical connectors 121, 122. The auxiliary thermal conductive layer 140 has a second line impedance matching the first line impedance, and, hereby, the magnitudes of electric currents flowing into the primary thermal conductive layer 120 and the auxiliary thermal conductive layer 140 separately are roughly the same. In other words, when the difference between the first line impedance and the second line impedance is larger, under the same drive voltages provided by the driving power supply 160, most electric currents tend to flow through the path with a lower line impedance, resulting in the other path with a higher line impedance having insufficient electric current and, as a result, having a poor heating performance in the area along the path. Therefore, the matching between the second line impedance and the first line impedance is very important in the design of the present disclosure.

In several embodiments, to ensure that each electric current has approximately identical magnitude (that is, the line electric current) in the form of the current waterfall flowing separately into the primary thermal conductive layer 120 and the auxiliary thermal conductive layer 140, the second line impedance of the auxiliary thermal conductive layer 140 has a variance of about 3% to 5% with respect to the first line impedance of the transparent conductor layer 112 between the electrical connectors 121, 122. Having a variance within such a range indicates that the first line impedance and the second line impedance are matched.

More specifically, the primary thermal conductive layer 120 is configured with a first heating mode to start as soon as the power is on, so that the light-transmitting window area 113a is heated evenly. The auxiliary thermal conductive layer 140 is configured with a second heating mode to start as soon as the power is on, so that the light-impermeable area 113b is heated. As described previously, the driving power supply 160 applies a driving voltage to the primary thermal conductive layer 120 and the auxiliary thermal conductive layer 140 in parallel. Therefore, the first heating mode and the second heating mode will be operating simultaneously. For example, the first heating mode can be a defogging mode, and the second heating mode can be a deicing mode.

In several embodiments, the auxiliary thermal conductive layer 140 comprises an opaque metal or metal composition. For example, the auxiliary thermal conductive layer 140 can be a patterned silver (Ag) wire layer. However, the present disclosure is not limited thereto.

In several embodiments, the primary thermal conductive layer 120 can also be a patterned silver wire layer. However, the present disclosure is not limited thereto.

In several embodiments, each of the two electrical connectors 121, 122 (that is, conductive busbars) has a resistance value smaller than about 1 Ohm. Low-resistance materials such as silver paste, for example, can ensure the resistance value is smaller than 1 Ohm. In several embodiments, the first line impedance of the transparent conductor layer 112, such as a transparent conductor layer of indium tin oxide (ITO) as an example, between the electrical connectors 121, 122, is in the range of about 25 Ohms to about 35 Ohms. Hereby, when the power is on, the portion of the transparent conductor layer 112 between the electrical connectors 121, 122 (and the light-transmitting window area 113a) is heated by the electric current flowing through. More specifically, the two electrical connectors 121 and 122, as the conductive busbars of low resistance (that is, under 1 Ohm), are designed for the purpose of having the electric current reach and be uniformly distributed in every position on the two electrical connectors 121 and 122. As for the transparent conductor layer 112, since the corresponding light-transmitting window area 113a requires higher transparency, ITO is preferable. However, ITO generally has relatively higher resistance and can form a thermal resistance effect rather than a simple conductor.

In the embodiment as shown in FIG. 2B, the light-transmitting window area 113 has two edges, 113al and 113a2, that are opposite to each other. The two electrical connectors, 121 and 122, at least partially overlap the two edges 113al and 113a2, respectively, in the stacking direction D. Hereby, when the power is on, the primary thermal conductive layer 120 can be used to heat up the light-transmitting window area 113a specifically.

In the embodiment as shown in FIG. 1, the heating assembly 100 further comprises a first anti-reflection layer 170 and a second anti-reflection layer 180. The first anti-reflection layer 170 is disposed on one side of the glass layer 111 that is away from the transparent conductor layer 112. The second anti-reflection layer 180 is disposed on one side of the transparent conductor layer 112 that is away from the glass layer 111. Please note that, due to the design of the present disclosure, which is focused on capturing images dynamically in self-driving vehicles, it is necessary to meet the requirement of decent transmittance to ensure road safety, and therefore, dual anti-reflection layers are embedded in the design, thus increasing transmittance of the electric heating plate 110. The vehicle camera system 10 of the embodiment will then meet the dynamic specification of lens 200 for self-driving vehicles.

In several embodiments, the first anti-reflection layer 170 has a multi-layer membrane structure. For example, parameters of each layer of the first anti-reflection layer 170 can be set as shown in Table 1.

TABLE 1

| Layer No. | Material | Thickness (nm) |
|---|---|---|
| 15 | SiO₂ | 88.14 |
| 14 | Nb₂O₅ | 113.25 |
| 13 | SiO₂ | 42.10 |
| 12 | Nb₂O₅ | 23.75 |
| 11 | SiO₂ | 40.26 |
| 10 | Nb₂O₅ | 130.41 |
| 9 | SiO₂ | 32.05 |
| 8 | Nb₂O₅ | 32.76 |
| 7 | SiO₂ | 36.76 |
| 6 | Nb₂O₅ | 41.28 |
| 5 | SiO₂ | 32.72 |
| 4 | Nb₂O₅ | 27.14 |
| 3 | SiO₂ | 52.27 |
| 2 | Nb₂O₅ | 7.84 |
| 1 | SiO₂ | 20 |

Please note that the first anti-reflection layer 170 is in contact with the glass layer 111 through the layer membrane of layer number 15.

In several embodiments, the second anti-reflection layer 180 has a multi-layer membrane structure. For example, parameters of each layer of the second anti-reflection layer 180 can be set as shown in Table 2.

TABLE 2

| Layer No. | Material | Thickness (nm) |
|---|---|---|
| 15 | SiO₂ | 88.38 |
| 14 | Nb₂O₅ | 112.76 |
| 13 | SiO₂ | 41.84 |
| 12 | Nb₂O₅ | 16.96 |
| 11 | SiO₂ | 13.37 |
| 10 | Nb₂O₅ | 5.99 |
| 9 | SiO₂ | 34.11 |
| 8 | Nb₂O₅ | 14.79 |
| 7 | SiO₂ | 4.05 |
| 6 | Nb₂O₅ | 46.62 |
| 5 | SiO₂ | 4.65 |
| 4 | Nb₂O₅ | 54.02 |
| 3 | SiO₂ | 43.31 |
| 2 | Nb₂O₅ | 16.49 |
| 1 | SiO₂ | 78.19 |

Please note that the second anti-reflection layer 180 is in contact with the primary thermal conductive layer 120 on the layer membrane of layer number 15, and the second anti-reflection layer 180 is connected to the transparent conductor layer 112 on the layer membrane of layer number 1.

Furthermore, to further increase the quantity of light that travels from the transparent conductor layer 112 into the second anti-reflection layer 180, an additional index-matching layer can be disposed between the aforementioned two layers. For example, parameters of the index-matching layer can be set as shown in Table 3.

TABLE 3

| Layer No. | Material | Thickness (nm) |
|---|---|---|
| 4 | ITO | 22 |
| 3 | SiO₂ | 66.12 |
| 2 | Nb₂O₅ | 5.31 |
| 1 | SiO₂ | 15 |

Please note that the index-matching layer is in contact with the second anti-reflection layer 180 on the layer membrane of layer number 4, and the index-matching layer in contact with the transparent conductor layer 112 on the layer membrane of layer number 1.

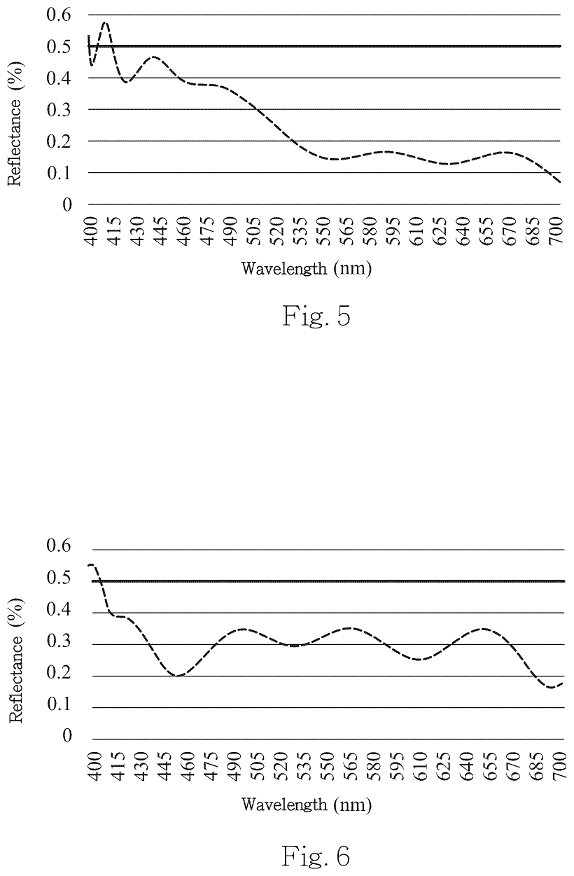

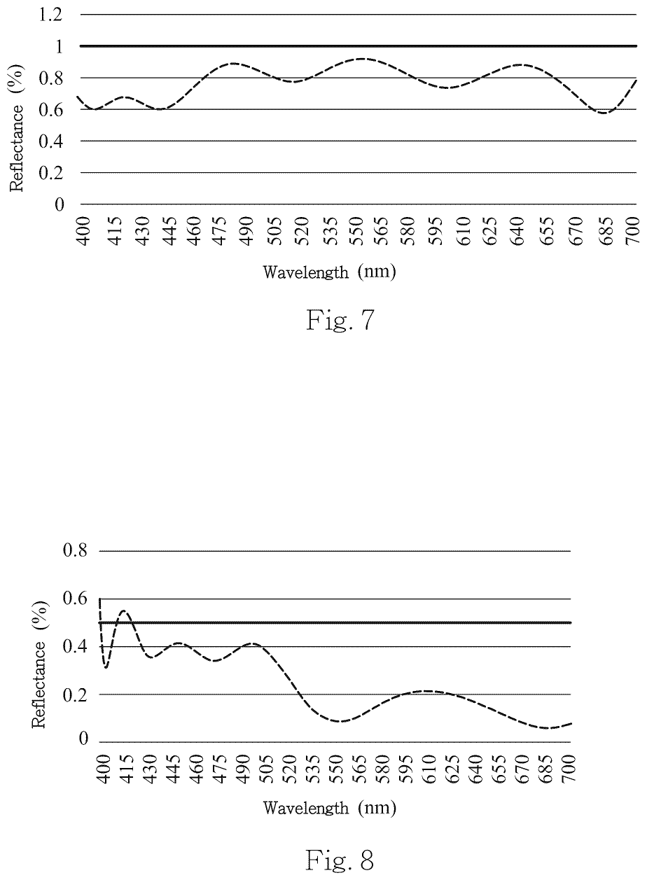

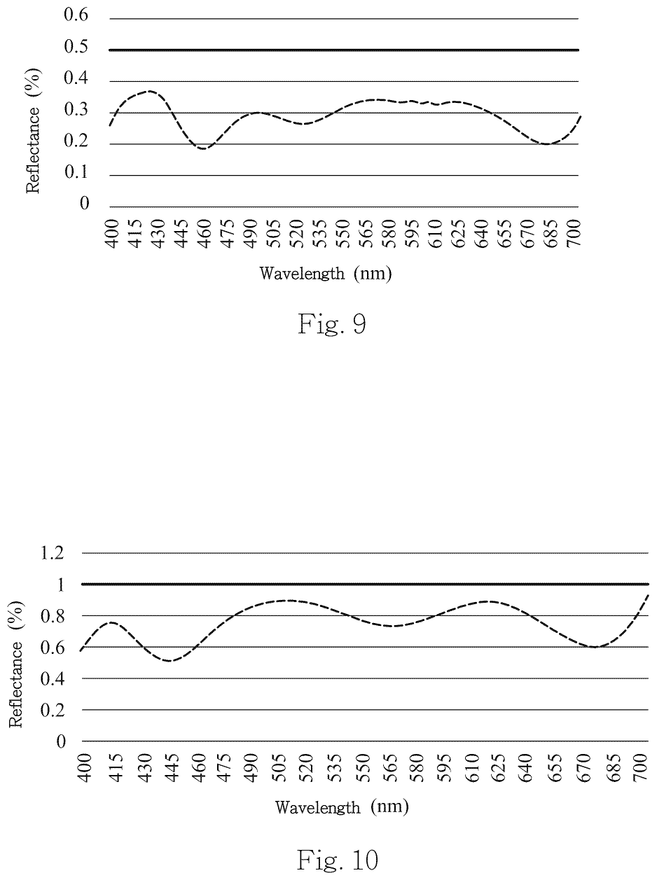

Please refer to the diagrams from FIG. 5 to FIG. 10. FIG. 5 shows a wavelength-reflectance curve of light having an angle of incidence (AOI) of 0 degree to the outer side of the heating assembly 100 away from the lens 200 shown in FIG. 1. FIG. 6 shows a wavelength-reflectance curve of light having an angle of incidence of 30 degrees to the outer side of the heating assembly 100 shown in FIG. 1. FIG. 7 shows a wavelength-reflectance curve of light having an angle of incidence of 42 degrees to the outer side of the heating assembly 100 shown in FIG. 1. FIG. 8 shows a wavelength-reflectance curve of light having an angle of incidence of 0 degree to the inner side of the heating assembly 100 close to the lens 200 shown in FIG. 1. FIG. 9 shows a wavelength-reflectance curve of light having an angle of incidence of 30 degrees to the inner side of the heating assembly 100 shown in FIG. 1. FIG. 10 shows a wavelength-reflectance curve of light having an angle of incidence of 42 degrees to the inner side of the heating assembly 100 shown in FIG. 1. Please note that FIG. 5 to FIG. 10 are the measurement results using the parameters in Table 1, Table 2, and Table 3 of the first anti-reflection layer 170, the second anti-reflection layer 180, and the index matching layer, respectively.

According to FIG. 5 and FIG. 6, when incident light at a wavelength of 400 nm to 700 nm is irradiated at an angle of incidence of 0 to 30 degrees to the outer side of the heating assembly 100, a reflectance of approximately less than 0.5% can be obtained. According to FIG. 6 and FIG. 7, when incident light at a wavelength of 400 nm to 700 nm is irradiated at an angle of incidence of 30 to 42 degrees to the outer side of the heating assembly 100, a reflectance of approximately less than 1% can be obtained. According to FIG. 8 and FIG. 9, when incident light at a wavelength of 400 nm to 700 nm is irradiated at an angle of incidence of 0 to 30 degrees to the inner side of the heating assembly 100, a reflectance of approximately less than 0.5% can be obtained. According to FIG. 9 and FIG. 10, when incident light at a wavelength of 400 nm to 700 nm is irradiated at an angle of incidence of 30 to 42 degrees to the inner side of the heating assembly 100, a reflectance of approximately less than 1% can be obtained. Please note that light within the wavelength range of 400 nm to 700 nm, which is also the specified wavelength range monitored by the camera, a reflectance of less than 0.5% or 1% can be achieved. In other words, due to a transmittance of above 99.5% or 99%, respectively, the quality of images captured dynamically by self-driving vehicles shall be ensured.

In several embodiments, the heating assembly 100 further comprises a hydrophobic coating layer 190. The hydrophobic coating layer 190 is disposed on one side of the first anti-reflection layer 170 away from the glass layer 111. Hereby, the design can effectively increase the difficulty for moisture condensing on the outer side of the heating assembly 100.

According to the detailed descriptions of embodiments of the present disclosure, it is apparent that, through a double-layer design of a primary thermal conductive layer and an auxiliary thermal conductive layer, having a first line impedance of the transparent conductor layer between the electrical connectors and a second line impedance of the auxiliary thermal conductive layer that matches the first line impedance in design, not only can the heating coverage area of the heating assembly within the present disclosure increase, but the primary thermal conductive layer and the auxiliary thermal conductive layer can also separately achieve two different heating modes simultaneously according to the needs of the environment. Furthermore, the two edges of the electric heating plate of the heating assembly, opposite to each other, are disposed with a first anti-reflection layer and a second anti-reflection layer, respectively, to increase the transmittance of the electric heating plate so that the vehicle camera system of the present disclosure can meet the dynamic specification of autopilot lenses.

The above embodiments are presented to disclose the present disclosure and shall not be interpreted as limitations to the scope, applicability, or configuration of the present disclosure in any way. Those skilled in the art may use any alternative embodiments that are modified or changed without departing from the spirit and scope of the present disclosure and shall be included in the appended claims.

### COMPONENT SYMBOL

10: Vehicle camera system
100: Heating assembly
110: Electric heating plate
111: Glass layer
112: Transparent conductor layer
113: Decorative layer
113a: Light-transmitting window area
113a1, 113a2: Edge
113b: Light-impermeable area
120: Primary thermal conductive layer
121, 122: Electrical connector
130: First insulating layer
140: Auxiliary thermal conductive layer
150: Second insulating layer
160: Driving power supply
161: Lap joint area
170: First anti-reflection layer
180: Second anti-reflection layer
190: Hydrophobic coating layer
200: Lens
210: Aperture
D: Stacking direction

What is claimed is:

1. A heating assembly, comprising:
an electric heating plate, comprising:
a glass layer;
a transparent conductor layer, disposed on the glass layer; and
a decorative layer, located between the glass layer and the transparent conductor layer and defining a light-transmitting window area and a light-impermeable area;
a primary thermal conductive layer, comprising two electrical connectors respectively disposed on opposite sides of the transparent conductor layer, wherein the transparent conductor layer has a first line impedance between the two electrical connectors;
a first insulating layer, covering the primary thermal conductive layer;
an auxiliary thermal conductive layer, comprising an opaque metal or metal composition and covering the first insulating layer, wherein the auxiliary thermal conductive layer forms a patterned continuous wiring corresponding to the decorative layer and at least partially overlaps the primary thermal conductive layer corresponding to a stacking direction of the primary thermal conductive layer, and the auxiliary thermal conductive layer has a second line impedance matching the first line impedance; and
a driving power supply, which applies a driving voltage to the primary thermal conductive layer and the auxiliary thermal conductive layer in parallel.

2. The heating assembly of claim 1, wherein the primary thermal conductive layer is configured with a first heating mode to start when power is on, so that the light-transmitting window area is heated evenly, the auxiliary thermal conductive layer is configured with a second heating mode to start when the power is on, so that the light-impermeable area is heated, and the second heating mode and the first heating mode are activated simultaneously.

3. The heating assembly of claim 1, wherein each of the two electrical connectors has a resistance value smaller than 1 Ohm.

4. The heating assembly of claim 1, wherein the first line impedance is in a range of 25 Ohms to 35 Ohms.

5. The heating assembly of claim 1, wherein a resistance of the second line impedance has a 3% to 5% difference from the first line impedance.

6. The heating assembly of claim 1, wherein the light-transmitting window area has two edges opposite to each other, and the two electrical connectors at least partially overlap the two edges in the stacking direction, respectively.

7. The heating assembly of claim 1, further comprising:
a first anti-reflection layer, disposed on one side of the glass layer away from the transparent conductor layer; and
a second anti-reflection layer, disposed on the transparent conductor layer away from the glass layer.

8. The heating assembly of claim 7, further comprising a hydrophobic coating layer, wherein the hydrophobic coating layer is disposed on one side of the first anti-reflection layer away from the glass layer.

9. The heating assembly of claim 1, further comprising a second insulating layer, wherein the second insulating layer covers the auxiliary thermal conductive layer.

10. A vehicle camera system, comprising:
the heating assembly of claim 1; and
a lens, located on one side of the electric heating plate where the primary thermal conductive layer is disposed and aligned with the light-transmitting window area in the stacking direction.
